(19) United States
(12) Patent Application Publication
(10) Pub. No.: US 2018/0272235 A1
(43) Pub. Date: Sep. 27, 2018

(54) SYSTEM AND METHOD FOR MODIFYING GAMEPLAY ACCORDING TO USER GEOGRAPHICAL LOCATION

(71) Applicant: MZ IP Holdings, LLC, Palo Alto, CA (US)

(72) Inventor: Stanley Lee, Fremont, CA (US)

(21) Appl. No.: 15/910,184

(22) Filed: Mar. 2, 2018

Related U.S. Application Data
(60) Provisional application No. 62/475,437, filed on Mar. 23, 2017.

(51) Int. Cl. A63F 13/79; A63F 13/35

(52) U.S. Cl. CPC A63F 13/79; A63F 13/35

(57) ABSTRACT

Implementations of the present disclosure are directed to a method, a system, and an article for updating a game or other application using data associated with a geographical location of a user. An example method can include: providing, on a client device, a game having a set of gameplay characteristics; determining a geographical location of the client device; determining at least one condition of the geographical location; modifying at least one of the gameplay characteristics according to the at least one condition; and providing, on the client device, a modified version of the game including the at least one modified gameplay characteristic.

### CROSS-REFERENCE TO RELATED APPLICATIONS

This application claims the benefit of U.S. Provisional Patent Application No. 62/475,437, filed Mar. 23, 2017, the entire contents of which are incorporated by reference herein.

### BACKGROUND

The present disclosure relates to multi-player online games and, in some examples, to systems and methods for managing the sharing and use of global position information for mobile devices in multi-player online games.

In general, a multi-player online game can be played by hundreds of thousands or even millions of players who use client devices to interact with a virtual environment for the online game. The players are typically working to accomplish tasks, acquire assets, or achieve a certain score or level in the online game. Some games require or encourage players to form groups or teams that can play against other players or groups of players.

In a typical example, a player interacts with the virtual environment by providing input to a user input device. Common user input devices for games can include, for example, a touch screen, a keypad, a joystick, and/or a keyboard. With a touch screen, users can interact with the virtual environment by tapping or selecting items displayed on the screen.

Many mobile client devices include components that allow global positions of the mobile devices to be determined, for example, through the use of a global positioning system or radio tower multilateration. Users typically can choose between sharing or not sharing such global position information from the mobile devices.

### SUMMARY

In general, the systems and methods described herein relate to online games and other applications that access and use global position information for mobile client devices. A geographical location of a user's client device can be determined, for example, based on radio tower multilateration or an IP address. One or more conditions at the geographical location (e.g., weather, time of day, market conditions, or other “live” data that is associated with a user's geographical location) can be determined by the client device and/or a server. Based on the determined conditions, certain gameplay characteristics for a game running on the client device can be modified. The gameplay characteristics can relate to or define a way in which the user interacts with the game. The gameplay characteristics can include, for example, a plot for the game and/or a player's connection to the plot, a pattern defined by rules for the game, challenges in the game and/or a player's ability to overcome the challenges, or different graphical/visual representations, behaviors, features, and functionalities to enhance the virtual environment experienced by the user. Advantageously, the approach of modifying gameplay according to conditions at a user's location can significantly improve the user's connection to the game and overall user interest in the game. The approach can also improve computer functionality by providing virtual environments that more closely resemble or mimic conditions in the user's actual environment.

In some instances, for example, use of global position information can improve user engagement with an online game by connecting users with other users who are located in a similar physical region (e.g., neighborhood, city, or state). Such users can be introduced to one another and/or encouraged to interact with one another in a common virtual environment. Alternatively or additionally, such users can be encouraged to form teams that compete in the online game with other teams from different physical regions. Such affiliations with other users from the same or similar community can result in more user enjoyment and/or satisfaction with the online game.

Additionally or alternatively, the approach described herein can enable a more efficient utilization of network bandwidth, networking equipment, or the like. For example, given that each user can have gameplay tailored according to geographical location, the systems and methods described herein can send any modifications and/or updates for a geographical location to particular users in the geographical location, without having to send such modifications and/or updates to every other user. In other words, a modification and/or update provided to certain users based on a new condition at the users' geographical location may not need to be provided to other users located outside the geographical location. This can save significant network bandwidth, particularly for games involving millions of users playing at any one time in different geographical locations around the world.

Additionally or alternatively, in certain examples, the online game can guide or encourage such users to connect with one another in a real world environment (e.g., outside of the virtual environment). The users can be encouraged to perform tasks together (e.g., a scavenger hunt in a theme park) to gain virtual items or other rewards for use in the virtual environment. The approach can integrate online and offline experience and create social connections among users, thereby improving user interest in and engagement with the online game.

Advantageously, use of the global position information can further enhance online games and other applications that involve augmented reality. A conventional augmented reality application can detect and display real world objects (e.g., trees or buildings) and add virtual elements to the display. With the approach described herein, however, the display can be further augmented according to a known global position of the user. For example, virtual representations of people, animals, or objects corresponding to the known global position (e.g., a city or theme park) can be added to the display.

In one aspect, the subject matter described in this specification relates to a computer-implemented method. The method includes: providing, on a client device, a game having a set of gameplay characteristics; determining a geographical location of the client device; determining at least one condition of the geographical location; modifying at least one of the gameplay characteristics according to the at least one condition; and providing, on the client device, a modified version of the game including the at least one modified gameplay characteristic.

In certain examples, the client device is or includes at least one of a mobile device and a gaming console. The gameplay characteristics can include a game rule, a game challenge, a game plot, a virtual item, a game character, a user ability, and/or any combination thereof. Determining the geographical location can include using a global positioning system, a radio signal multilateration system, and/or an IP address of the client device. Determining the at least one condition can include retrieving the at least one condition from a third-party service and/or a publish-subscribe system. The step of determining the at least one condition can be performed periodically. The at least one condition can include climate information, weather information, stock market information, current events information, local time, holiday information, and/or any combination thereof.

In some implementations, modifying at least one of the gameplay characteristics can include: (i) presenting a user with a new challenge in the game; (ii) modifying an ability of a user to interact with a virtual environment of the game; (iii) modifying at least one of an availability, type, and cost of a virtual item in the game; (iv) modifying at least one of a frequency and type of virtual characters in the game; and/or (v) providing a different graphical/visual representation to enhance the virtual environment of the game. The method can include updating a display of the game on the client device according to the determined at least one condition. The method can include receiving permission from a user of the client device to modify the at least one of the gameplay characteristics according to the at least one condition.

In another aspect, the subject matter described in this specification relates to a system. The system includes one or more computer processors programmed to perform operations that include: providing, on a client device, a game having a set of gameplay characteristics; determining a geographical location of the client device; determining at least one condition of the geographical location; modifying at least one of the gameplay characteristics according to the at least one condition; and providing, on the client device, a modified version of the game including the at least one modified gameplay characteristic.

In certain examples, the client device is or includes at least one of a mobile device and a gaming console. The gameplay characteristics can include a game rule, a game challenge, a game plot, a virtual item, a game character, a user ability, and/or any combination thereof. Determining the geographical location can include using a global positioning system, a radio signal multilateration system, and/or an IP address of the client device. Determining the at least one condition can include retrieving the at least one condition from a third-party service and/or a publish-subscribe system. The step of determining the at least one condition can be performed periodically. The at least one condition can include climate information, weather information, stock market information, current events information, local time, holiday information, and/or any combination thereof.

In some implementations, modifying at least one of the gameplay characteristics can include: (i) presenting a user with a new challenge in the game; (ii) modifying an ability of a user to interact with a virtual environment of the game; (iii) modifying at least one of an availability, type, and cost of a virtual item in the game; (iv) modifying at least one of a frequency and type of virtual characters in the game; and/or (v) providing a different graphical/visual representation to enhance the virtual environment of the game. The operations can include updating a display of the game on the client device according to the determined at least one condition. The operations can include receiving permission from a user of the client device to modify the at least one of the gameplay characteristics according to the at least one condition.

In another aspect, the subject matter described in this specification relates to an article. The article includes a non-transitory computer-readable medium having instructions stored thereon that, when executed by one or more computer processors, cause the computer processors to perform operations that include providing, on a client device, a game having a set of gameplay characteristics; determining a geographical location of the client device; determining at least one condition of the geographical location; modifying at least one of the gameplay characteristics according to the at least one condition; and providing, on the client device, a modified version of the game including the at least one modified gameplay characteristic.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims.

### DESCRIPTION OF THE DRAWINGS

FIG. 1 is a schematic diagram of an example system for managing the use of global position information in a multi-player online game.

FIG. 2 is a schematic diagram of an example system in which a mobile client device is located within a target geographical region and is in communication with cell phone towers and a local network.

FIG. 3 is a flowchart of an example method of modifying gameplay in an online game according to a geographical location of a client device.

FIGS. 4A and 4B are schematic diagrams of example systems for modifying gameplay in an online game according to a geographical location of a client device.

### DETAILED DESCRIPTION

In various implementations, the subject matter of this disclosure relates to the use of global position information (e.g., geographical location information) for mobile devices to modify the gameplay of online games or other applications. The global position information can be or include, for example, latitude and longitude coordinates and/or a description of a geographical location, such as a street address, a neighborhood, a park, a region, a city, a state, and/or a country. The global position information for a mobile device can be obtained using, for example, a global positioning system (GPS) and/or radio tower multilateration (e.g., cell phone tower triangulation). Other suitable techniques for determining the global position of the mobile device are possible.

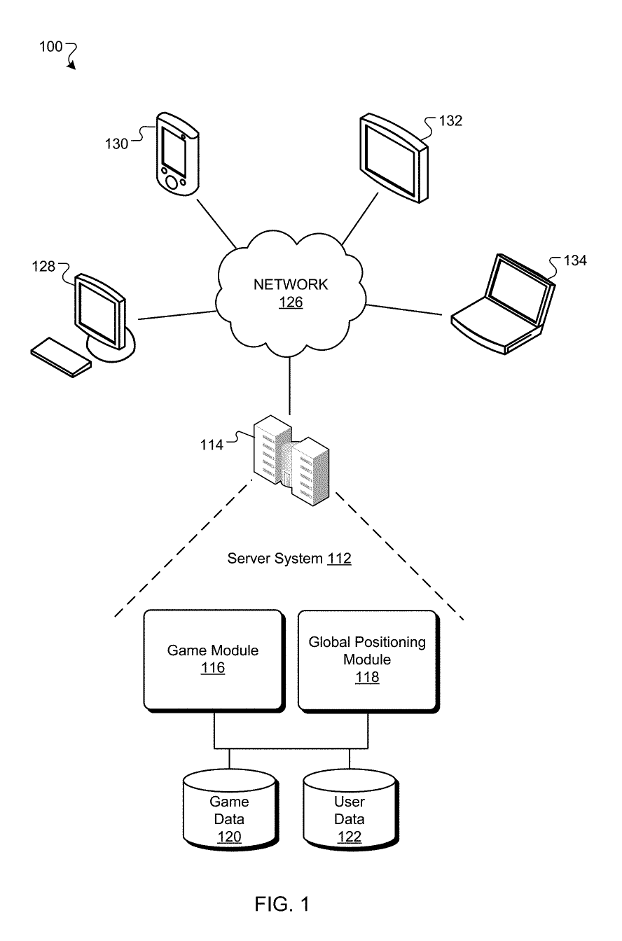

FIG. 1 illustrates an example system 100 for determining and using global position information in a multi-player online game. A server system 112 provides functionality for providing an online game that utilizes global position information obtained from mobile client devices. The server system 112 includes software components and databases that can be deployed at one or more data centers 114 in one or more geographical locations, for example. The server system 112 software components can include a game module 116 and a global positioning module 118. The software components can include subcomponents that can execute on the same or on different individual data processing apparatus. The server system 112 databases can include game data 120 and user data 122 databases. The databases can reside in one or more physical storage systems. The software components and data will be further described below.

An application, such as, for example, a web-based application, can be provided as an end-user application to allow users (also referred to herein as “players”) to interact with the server system 112. The end-user application can be accessed through a network 126 (e.g., the Internet) by users of client devices, such as a personal computer 128, a smart phone 130, a tablet computer 132, and a laptop computer 134. Other client devices are possible. In alternative examples, the game data 120 and/or the user data 122 or any portions thereof can be stored on one or more client devices. Additionally or alternatively, software components for the system 100 (e.g., the game module 116 and/or the global positioning module 118) or any portions thereof can reside on or be used to perform operations on one or more client devices.

FIG. 1 depicts the game module 116 and the global positioning module 118 as being able to communicate with the databases (e.g., the game data 120 and the user data 122 databases). The game data 120 database generally includes information related to the multi-player online game implemented using the system 100. The game data 120 database can include, for example, information related to a virtual environment for the game, image, video and/or audio data for the game, event data corresponding to previous, current or future game events, and/or game state data defining a current state of the game. The user data 122 database generally includes data related to user interactions with the online game and/or the virtual environment. Such information can be or include, for example, a history of user connections to the system 100, user purchases, user accomplishments, user tasks, user interactions with other users (e.g., group chats), user virtual item acquisition or usage, and/or other user conditions in the virtual environment and/or real world. The user data 122 database can include information related to the global positions of mobile client devices, such as, for example, a history of times and/or locations where users interacted with the online game.

In various examples, the users or players of the online game can have certain user capabilities in the virtual environment. The user capabilities can be or include, for example, moving an avatar or a virtual item or object to a different geographical location, interacting with characters or other users, participating in user groups or alliances, attacking other users, deploying troops, defending against an attack from other users, deploying defenses, building or modifying a virtual item or object (e.g., a virtual building or other structure), developing a new skill, operating a vehicle, acquiring a virtual item (e.g., a weapon), using or interacting with a virtual item (e.g., a playing card or a weapon), and performing supernatural tasks (e.g., casting a spell). Other user capabilities are possible.

The virtual environment for the online game can be rendered for users in the form of, for example, graphics, images, video, audio, text, and/or haptic feedback. In an adventure game, for example, a graphical user interface can display a virtual environment that includes representations of characters (e.g., people or animals), natural features (e.g., mountains, rivers, fields, trees, and/or weather conditions), and/or man-made features (e.g., buildings, bridges, and/or vehicles).

In some examples, when a user's physical location is known (e.g., based on global position information from the user's mobile device), the rendering of the online game can be adapted or enhanced according to the physical location. For example, the online game can provide the user with an enhanced virtual environment that includes representations of one or more features and/or conditions (e.g., weather or the like) at or in close proximity to the user's physical location. To determine environmental conditions, for example, the online game can obtain local weather information and/or daylight conditions from one or more weather databases or weather forecast services (e.g., OPENWEATHERMAP or ACCUWEATHER). The enhanced virtual environment can then be provided with representations of cloud conditions, precipitation (e.g., rain or snow), wind, sun position, moon phase, and/or moon position, and the like, corresponding to current conditions in the user's physical location. In some instances, users who are physically located near one another (e.g., in the same building, neighborhood, park, or city) can experience the same enhanced virtual environment and/or can interact with one another within the enhanced virtual environment. Other users who are far away or in remote physical locations may be unable to access the enhanced virtual environment.

In some examples, an enhanced virtual environment can allow users to experience certain game features and/or have certain capabilities that may not be available outside of the enhanced virtual environment (e.g., in an unenhanced or original virtual environment for the game). For example, the enhanced virtual environment can allow users to view or experience special themes (e.g., colors, decorations, characters, clothing, structures, music, etc.) and/or acquire unique assets (e.g., virtual clothing, gifts, weapons, etc.). Alternatively or additionally, the enhanced virtual environment can allow users to play one or more variations of the online game, for example, according to different rules. The game variations can be more favorable to users in certain respects, when compared to game play in the original virtual environment. For example, the game variations can allow the users to make advancements that may be more difficult to achieve in the original virtual environment. Additionally or alternatively, users can preferably obtain virtual items, points, level increases, or other assets or advancements that may not be available outside of the enhanced virtual environment. Additionally or alternatively, users can be presented with a separate online game, such as a mini-game or support game, which can be tailored to a particular geographical location and played while the mobile device is within or in close proximity to the target geographical location.

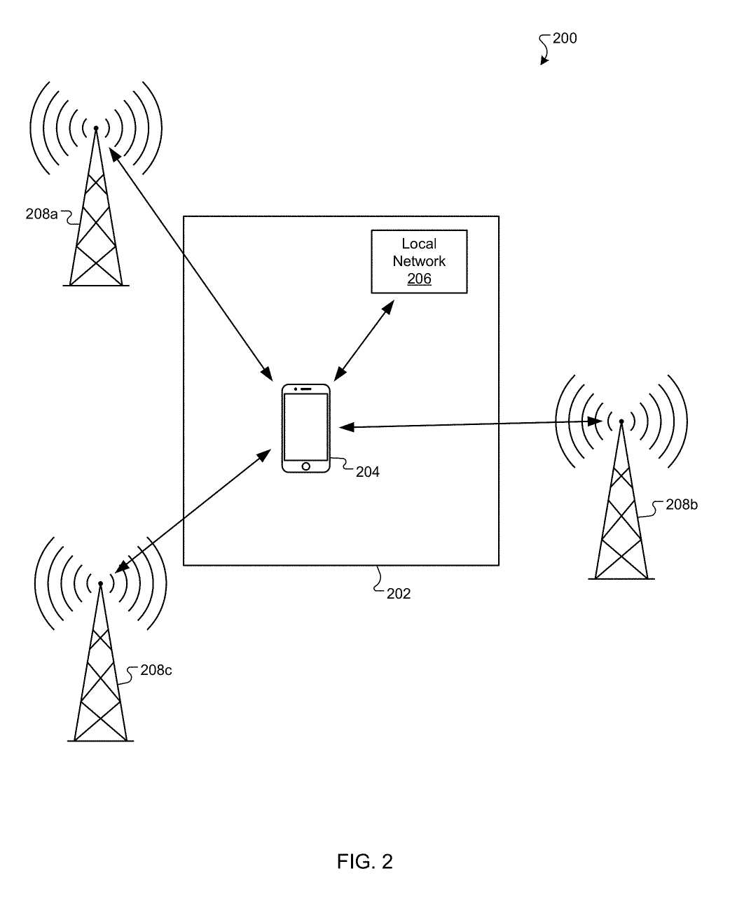

Referring to FIG. 2, for example, a system 200 can include a target geographical region 202, a mobile device 204, a local network 206, and a plurality of cell phone towers 208a, 208b, and 208c. In general, the target geographical region 202 is associated with an enhanced virtual environment for the online game and can be or include, for example, a room, a building, a street, a neighborhood, a park, a town, a city, a business, or other physical area. In various examples, when the mobile device 204 is already sharing global position information (e.g., obtained using the cell phone towers 208a, 208b, and 208c or through GPS functionality available on the mobile device 204) with the online game, the online game can confirm that the mobile device 204 is located within the target geographical region 202. The mobile device 204 can then provide different graphical/visual representations, behaviors, features, and/or functionalities in the enhanced virtual environment associated with the target geographical region 202.

In certain implementations, the use of global position information can allow users to be grouped in the virtual environment according to physical location. In an adventure game, for example, rather than allocating users to random virtual environments or virtual locations, users can be allocated according to their physical locations. This can allow users who live in or are visiting a specific city, state, or country, for example, to interact with one another in a virtual environment corresponding to the city, state, or country. The users could form groups or alliances that can compete against other groups or alliances, for example, of users from different physical locations. In one example, when a user travels to a different physical location, the user can become a guest player in a virtual environment for the physical location. The guest player can receive special gains or items as a guest that can only be retained if the user continues to share global position information. In this way, the online game can provide a virtual vacation experience when the user is traveling away from home. In preferred implementations, the sharing of global position information can be a prerequisite for such a game experience.

In various examples, “gameplay” refers to a way in which users or players can interact with a game (e.g., an online game) and can include how the game is presented with graphical or audio elements. Gameplay can be or include, for example, a plot for the game and/or a user's connection to the plot, a pattern defined by rules for the game, challenges in the game and/or a user's ability to overcome the challenges, a connection between a user and the game (e.g., an ability of the user to interact with a virtual environment for the game), or different graphical/visual representations, behaviors, features, and functionalities to enhance the virtual environment experienced by the user in the game. Gameplay can be governed by a set of rules that can define, for example, (i) a goal of the game, (ii) how a user can interact with the game, and/or (iii) how the game can be modified or adjusted. Alternatively or additionally, gameplay can be distinct from any graphical or audio elements used to present the game. In various instances, the systems and methods described herein can modify or adjust gameplay for a user of the game, based on one or more conditions that exist at the user's geographical location.

In some examples, gameplay can be modified (e.g., using the game module 116) based on a geographical location of the client device running or hosting the game. For instance, even if the client device is not within a “target geographical region,” as described herein, the gameplay can be modified according to conditions associated with any given geographical location of the client device and/or the user. These conditions can be accessed from information sources and can include climate or weather information (e.g., from a website or service such as openweathermap.com), stock market information (e.g., from yahoo.com), current events or news information (e.g., from local or national news sources), local time, local holiday calendar, and the like.

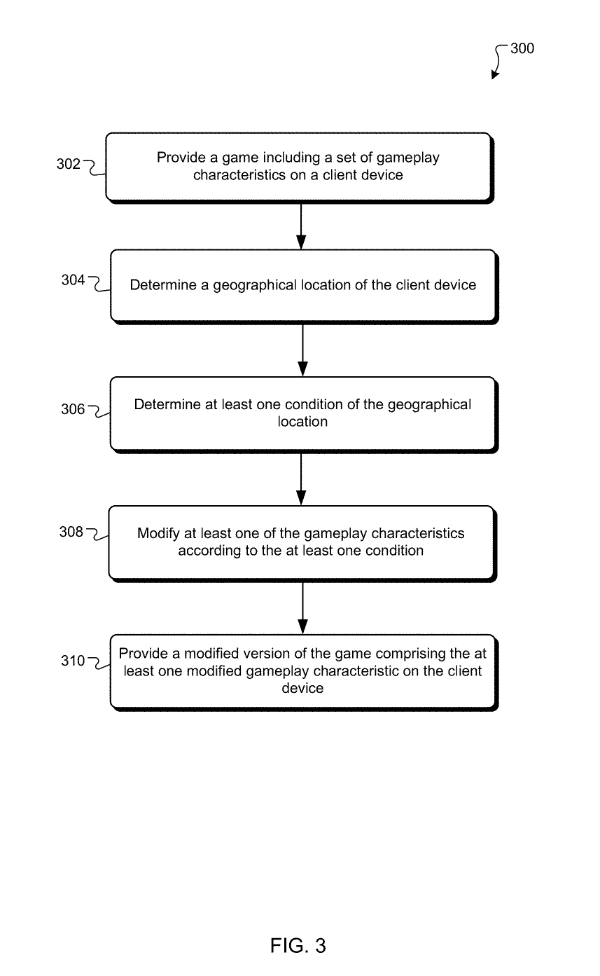

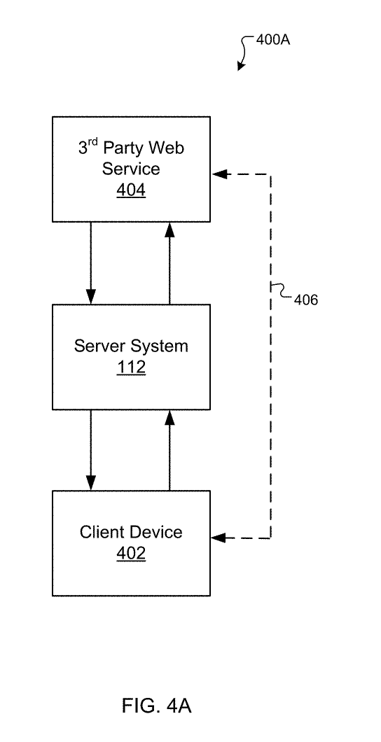

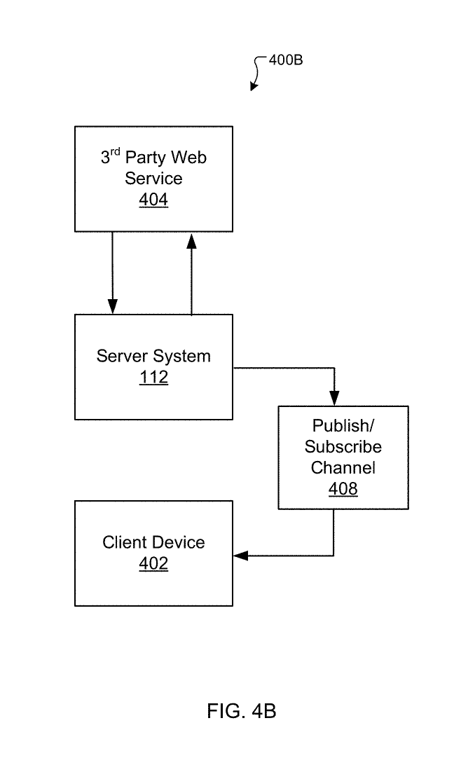

FIG. 3 illustrates an example computer-implemented method 300 for modifying gameplay in a game based on a geographical location of a client device. FIGS. 4A and 4B include schematic diagrams of example systems 400A and 400B, respectively, that can be used to implement the method 300. FIGS. 3, 4A, and 4B are discussed together herein. In step 302, a game having a set of gameplay characteristics can be provided on a client device 402 using, for example, an application client for the game.

In step 304, the geographical location of the client device 402 can be determined using, for example, GPS, radio or cell phone tower multilateration or triangulation, an IP address of the client device, latitude and longitude information, and the like. In general, the game can receive the geographical location information from the client device 402 and/or from the server system 112 (e.g., using the game module 116 and/or the global positioning module 118). The client device 402 can determine the geographical location by performing appropriate geolocation calculations and/or by making a suitable query to the server system 112, which can perform the geolocation calculations on behalf of the client device 402. The client device 402 can be or include, for example, a mobile device (e.g., a smartphone, tablet, laptop, notebook computer, or mobile gaming device), a personal computer, a desktop computer, or a gaming console (e.g., a console for PLAYSTATION, XBOX, WII, and the like). Data used to determine the geographical location of the client device 402 (e.g., GPS data or cell phone triangulation data) can be stored on the client device 402 and/or in a database that the server system 112 can access (e.g., the game data 120 database and/or the user data 122 database).

In various instances, the geographical location of the client device can be determined periodically, for example, at fixed periods of time (e.g., intervals of 10 seconds, 1 minute, 1 hour, 6 hours, 1 day, or more). Depending on a movement history of the client device 402 and/or on a length of the time periods, it may not be necessary to recalculate the geographical location of the client device 402 at each time period. When the movement history indicates that the client device 402 has been stationary or moving slowly (e.g., by foot), for example, it may be unnecessary to recalculate geographical location at each time period, particularly when the time periods are small (e.g., 10 seconds or 1 minute). In such instances, recalculation of the geographical location can be performed after a certain number of time periods (e.g., 5, 10, 100 or more) have elapsed. Alternatively or additionally, when the movement history indicates that the client device 402 is moving rapidly (e.g., by car, bus, train, or plane), it can be desirable to recalculate geographical location more frequently, for example, at each time period.

Next, in step 306, one or more conditions (e.g., related to weather, financial markets, etc.) in the geographical location of the client device 402 can be determined by obtaining information from various sources. In certain instances, the information can be obtained from one or more third party web services 404, for example, by interfacing with an application programming interface (API) provided by the web services (e.g., by making appropriate API calls to web services that expose APIs). In system 400A, for example, the client device 402 can request one or more conditions for the geographical location from the server system 112. The server system 112 can then obtain the condition information from the one or more web services 404 and return the information to the application client 402. For example, the server system 112 can access the information, process the information to determine at least one condition, and provide the at least one condition to the client 402. In another example, the application client 402 can directly request and obtain the at least one condition from the third party web service 404, using a connection 406.

Alternatively or additionally, as shown in system 400B, the server system 112 can retrieve condition information from the third party web services 404 and transmit the information to the client device 402 using a publish-subscribe platform. In this case, the client device 402 can subscribe to one or more channels 408 of the publish-subscribe platform or system that publish the condition information. For example, the client device 402 can subscribe to a weather channel to obtain periodic weather updates for the geographical location. The publish-subscribe platform can be or include, for example, the SATORI® live data platform provided by Machine Zone, Inc. (http://www.satori.com). Such real-time messaging platforms are preferably capable of transmitting and processing data at or near real-time with low latency. U.S. patent application Ser. No. 15/442,036, filed Feb. 24, 2017, describes a publish-subscribe messaging system and is incorporated by reference herein in its entirety.

In step 308, one or more gameplay characteristics of the game can be modified on the client device 402, according to one or more conditions for the geographical location, as described herein. Based on the geographical location, gameplay can be modified to achieve, for example, one or more of the following: (i) present the user with a new challenge (or remove a challenge) in the game; (ii) modify an ability of the user to interact with the virtual environment of the game; (iii) modify an availability, type, and/or cost of a virtual item in the game; (iv) modify a type and/or a number of virtual characters with whom the user can interact in the game; and/or (v) provide different graphical/visual representations, behaviors, features, and functionalities to enhance the virtual environment experienced by the user. In some examples, a user interface for the game can notify the user that a characteristic of gameplay has been changed. In other examples, one or more gameplay characteristics can be modified without notifying the user.

In some examples, a combination of conditions can be used to further modify gameplay as compared to modifications based on a single condition. For example, if there is a natural disaster and an economic downturn in the geographical location, then gameplay can be modified (e.g., a reduction in game challenges or difficulty) by more than if only one of the conditions (natural disaster or economic downtown) exists. Though there are two conditions in this example that can modify gameplay, the resulting change to gameplay may not be a linear or additive combination of the changes that would occur due to each condition individually. For example, the two or more conditions can cancel each other out or incrementally build on one another. In some examples, the at least one condition of the geographical location can be used to change multiple gameplay characteristics. When the condition is a holiday, such as Halloween, multiple gameplay characteristics of the game can change, including, for example, an availability or type of virtual items (e.g., Halloween costumes, different weaponry, and the like), type of virtual characters (e.g., zombies or trick-or-treaters), etc. Additionally or alternatively, graphical and/or audio representations of the game can change (e.g., spooky decorations can be displayed or spooky music can be played).

In certain examples, one or more conditions of the geographical location can be used to present the user with a new challenge or to modify or remove one or more challenges in the game. For instance, in the context of an adventure game, a boom in a local stock market can cause the game to present an option for the user to collect more coins or other virtual currency. Additionally or alternatively, prices for items in a virtual market can change according to market conditions. When the condition is a natural disaster, a plot for the game can be modified, for example, to include or use a different branch in an overall plot for the game. For instance, the modified plot can include an escape challenge from a region in the game, to avoid or escape the natural disaster. The user may be required, for example, to escape a region in the game experiencing a virtual wildfire, just as real wildfires may be raging nearby in real life for the user.

In some instances, one or more conditions of the geographical location can be used to modify an ability of the user to interact with a virtual environment, which can cause an increase or decrease in gameplay difficulty. For instance, conditions such as stormy weather, a nearby earthquake, or an economic downturn in a local economy can make it more difficult for the user to navigate the virtual environment and/or accomplish tasks in the game. For example, a movement speed of the user's character (or other characters) can be slowed in rainy or snowy conditions in the game. Alternatively or additionally, the gameplay can become easier during certain conditions (e.g., favorable weather or a natural disaster) to provide relief or advantages for the user. During a natural disaster, for example, the game can protect affected users by providing certain resources (e.g., virtual food) or by making the users less vulnerable to attack and/or to a loss of assets (e.g., by deploying a virtual shield).

In various implementations, one or more conditions of the geographical location can be used to modify an availability, type, and/or cost of a virtual item. For instance, a condition such as rain or snow can result in an increase in the availability of umbrellas or snow tires that a game character may find helpful. Likewise, when there is a natural disaster (e.g., an earthquake) near the user's location, the user in the game can be provided with certain virtual items (e.g., a peace shield) that can be used to protect the user or to make the user less vulnerable. In another example, when a local time condition changes from daytime to nightfall, one or more virtual items in the game (e.g., a flashlight or headlamp) can become available and/or change. Additionally or alternatively, certain tasks (e.g., travel or construction) can be easier to accomplish during daylight hours, while other tasks (e.g., attacking an enemy or hiding) can be easier to accomplish during nighttime. In some examples, the cost of a virtual item (e.g., a virtual shield) can be changed according to local conditions, such as a wildfire or a stock market crash. In another example, when there is a shortage of certain foods in the user's location, an availability of virtual food in the game can change (e.g., decrease) for the user.

In certain examples, one or more conditions of the geographical location can be used to modify a type and/or frequency of virtual characters in the game. Game characters can include, for example, a user's character (e.g., an avatar), characters for other users (e.g., in a multi-player game), characters that are part of the virtual environment (e.g., wildlife), adversarial characters, and/or any other characters that are part of the game or a story for the game. For instance, during an economic downturn, there can be an increase in virtual representations of criminals, thieves, and/or homeless people in the game. Likewise, during a holiday, there can be new types of characters, such as, for example, costumed people in a Mardi Gras parade or veterans in uniform during Veteran's Day or Memorial Day.

In various implementations, the systems and methods described herein can modify a graphical and/or audio representation of the virtual environment. For instance, the visual representation of the game can reflect one or more conditions of the geographical location of the user. For instance, local weather conditions can be graphically represented in the game, in the form of rainfall, snowfall, wind, and the like. Similarly, the amount or timing of daylight a user has in the game can depend on the geographical location of the user. In another example, the flora, fauna, and/or architecture depicted in the game can be modified to reflect that of the local environment of the user. Additionally or alternatively, when the user travels to a different location (e.g., from a chilly urban environment to a tropical environment), visual representations of the scenery, foliage, architecture, etc. can change accordingly. In some instances, when a geographical location of a user is changing rapidly, the game can determine that the user is traveling and can visually represent such travel on the client device. For example, the client device can display changes in scenery that are consistent with actual changes of scenery being experienced by the user.

In various examples, the geographical location can be or correspond to a country, a state, a city, a neighborhood, a property, or a building. Many conditions, such as economic conditions and/or natural disasters, can cover large regions and/or do not require a precise determination of a user's location to be taken into consideration. Other conditions, however, can be based on a more precise determination of the user's location and/or the user's environment. For instance, the client device 402 and/or the game can determine (e.g., based on an IP address) that a user is on a particular property and/or in a particular building and can modify gameplay accordingly. When the game determines that a user has been in a hospital for a certain threshold period of time (e.g., 6 hours or more), for example, the game can display a hospital setting (e.g., hospital beds or medical staff) and/or gameplay difficulty can be decreased based on an assumption that the user or a loved one may be injured or sick. Additionally or alternatively, the game can make certain virtual items available to the user (e.g., medical equipment, bandages, oxygen masks, wheelchairs, etc.) for use in the game. In another example, if the user is in a shopping mall or store, the game can display a store, storefronts, and/or vendors, while virtual items can be made available (e.g., for purchase) in the game, based on an assumption that the user is presently in a shopping mode. In a shopping mall virtual environment, there can be an increased variety of virtual items (e.g., a greater number of colors for a jacket) as compared to other regions of the virtual environment.

In some instances, the game can determine that two or more users are in close proximity to one another (e.g., in the same building or within a certain distance) in the geographical location and can make certain recommendations to the users. For example, one user can be offered suggestions regarding how the user can become more like another user in the game. Such suggestions can include, for example, a recommendation to acquire or purchase virtual items that the other player possesses.

In step 310, the modified version of the game that includes the at least one modified gameplay characteristic can be provided on the client device. This can include notifying the user regarding the modification, asking and/or receiving permission from the user for modifying a game (or part of the game), and/or displaying the modification. In some examples, the processes described herein can occur periodically, for example, at intervals of 30 minutes or less, 15 minutes or less, 5 minutes or less, etc. after the user initiates the game. Additionally or alternatively, such interval can depend on a type of condition involved. For example, weather conditions can be updated and implemented more frequently (e.g., every 10 minutes) than stock market conditions (e.g., every day). In some examples, the systems and methods described herein can use a suitable callback and synchronization mechanism that can preferably serialize actions, such that a queue of events can be ordered and actions can be synchronized by timestamp.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A computer-implemented method comprising:
providing, on a client device, a game comprising a set of gameplay characteristics;
determining a geographical location of the client device;
determining at least one condition of the geographical location;
modifying at least one of the gameplay characteristics according to the at least one condition; and
providing, on the client device, a modified version of the game comprising the at least one modified gameplay characteristic.

2. The method of claim 1, wherein the client device comprises at least one of a mobile device and a gaming console.

3. The method of claim 1, wherein the gameplay characteristics comprise at least one of a game rule, a game challenge, a game plot, a virtual item, a game character, and a user ability.

4. The method of claim 1, wherein determining the geographical location comprises:
using at least one of a global positioning system, a radio signal multilateration system, and an IP address of the client device.

5. The method of claim 1, wherein determining the at least one condition comprises:
retrieving the at least one condition from at least one of a third-party service and a publish-subscribe system.

6. The method of claim 1, wherein the step of determining the at least one condition is performed periodically.

7. The method of claim 1, wherein the at least one condition comprises at least one of climate information, weather information, stock market information, current events information, local time, and holiday information.

8. The method of claim 1, wherein modifying at least one of the gameplay characteristics comprises at least one of:
(i) presenting a user with a new challenge in the game;
(ii) modifying an ability of a user to interact with a virtual environment of the game;
(iii) modifying at least one of an availability, a type, and a cost of a virtual item in the game;
(iv) modifying at least one of a frequency and a type of virtual characters in the game; and
(v) providing a different graphical/visual representation to enhance the virtual environment of the game.

9. The method of claim 1, further comprising:
updating a display of the game on the client device according to the determined at least one condition.

10. The method of claim 1, further comprising:
receiving permission from a user of the client device to modify the at least one of the gameplay characteristics according to the at least one condition.

11. A system comprising:
one or more computer processors programmed to perform operations comprising:
providing, on a client device, a game comprising a set of gameplay characteristics;
determining a geographical location of the client device;
determining at least one condition of the geographical location;
modifying at least one of the gameplay characteristics according to the at least one condition; and
providing, on the client device, a modified version of the game comprising the at least one modified gameplay characteristic.

12. The system of claim 11, wherein the client device comprises at least one of a mobile device and a gaming console.

13. The system of claim 11, wherein the gameplay characteristics comprise at least one of a game rule, a game challenge, a game plot, a virtual item, a game character, and a user ability.

14. The system of claim 11, wherein determining the geographical location comprises:
using at least one of a global positioning system, a radio signal multilateration system, and an IP address of the client device.

15. The system of claim 11, wherein determining the at least one condition comprises:
retrieving the at least one condition from at least one of a third-party service and a publish-subscribe system.

16. The system of claim 11, wherein the step of determining the at least one condition is performed periodically.

17. The system of claim 11, wherein the at least one condition comprises at least one of climate information, weather information, stock market information, current events information, local time, and holiday information.

18. The system of claim 11, wherein modifying at least one of the gameplay characteristics comprises at least one of:
(i) presenting a user with a new challenge in the game;
(ii) modifying an ability of a user to interact with a virtual environment of the game;
(iii) modifying at least one of an availability, a type, and a cost of a virtual item in the game;
(iv) modifying at least one of a frequency and a type of virtual characters in the game; and
(v) providing a different graphical/visual representation to enhance the virtual environment of the game.

19. The system of claim 1, further comprising:
updating a display of the game on the client device according to the determined at least one condition.

20. An article, comprising:
a non-transitory computer-readable medium having instructions stored thereon that, when executed by one or more computer processors, cause the computer processors to perform operations comprising:
providing, on a client device, a game comprising a set of gameplay characteristics;
determining a geographical location of the client device;
determining at least one condition of the geographical location;
modifying at least one of the gameplay characteristics according to the at least one condition; and
providing, on the client device, a modified version of the game comprising the at least one modified gameplay characteristic.
